(19) United States
(12) Patent Application Publication
(10) Pub. No.: US 2024/0196376 A1
(43) Pub. Date: Jun. 13, 2024

(54) IMPROVEMENTS IN AND RELATING TO CELL CONFIGURATION AND CONTROL

(71) Applicant: Samsung Electronics Co., Ltd., Suwon-si (KR)

(72) Inventors: Yue WANG, Staines (GB); Junhyuk SONG, Suwon-si (KR)

(21) Appl. No.: 18/583,246

(22) Filed: Feb. 21, 2024

Related U.S. Application Data
(63) Continuation of application No. PCT/KR2022/012550, filed on Aug. 22, 2022.

(30) Foreign Application Priority Data
Aug. 23, 2021 (GB) 2112044.9
Aug. 1, 2022 (GB) 2211217.1

(51) Int. Cl. H04W 72/04; H04W 48/18; H04W 84/04

(52) U.S. Cl. CPC H04W 72/04; H04W 48/18; H04W 84/042

(57) ABSTRACT

A method of operating a telecommunication network, the network comprising at least one intelligent system and the network being configured in an O-RAN architecture, wherein cell configuration is controlled by means of one or more cell control information elements, IEs, facilitating control on a cell and/or slice level, wherein said control is effected via an E2 interface or an F1 interface.

### CROSS-REFERENCE TO RELATED APPLICATION(S)

This application is a continuation of International Application No. PCT/KR2022/012550 designating the United States, filed on Aug. 22, 2022, in the Korean Intellectual Property Receiving Office and claiming priority to United Kingdom Patent Application No. 2112044.9, filed on Aug. 23, 2021, in the United Kingdom Intellectual Property Office, and to United Kingdom Patent Application No. 2211217.1, filed on Aug. 1, 2022, in the United Kingdom Intellectual Property Office, the disclosures of all of which are incorporated by reference herein in their entireties.

### BACKGROUND

### Field

The present invention relates to a system and method for cell control in a telecommunication network. The invention applies, in particular, to an Open Radio Access Network (ORAN) system, but may be applied in other settings.

### Description of Related Art

The concept of open radio access network (Open RAN, O-RAN) is to enable an open and disaggregated radio access network architecture to improve network flexibility and avoid vendor lock-in. In order to encourage the development of a non-fragmented Open RAN system, the O-RAN alliance has developed the O-RAN architecture, that enables the building of a virtualised RAN on open hardware and cloud, with embedded AI powered radio control. Initiated by the O-RAN alliance, an O-RAN established by operators and equipment providers in a system that combines the 4G communication system with the 5G system, defines a new network element (NE) and interface specifications based on the existing 3GPP standard, and presents the O-RAN structure.

### SUMMARY

According to the present invention there is provided an apparatus and method as set forth in the appended claims. Other features of the invention will be apparent from the dependent claims, and the description which follows.

According to a first aspect of the present invention, there is provided a method of operating a telecommunication network, the network comprising at least one intelligent system and the network being configured in an O-RAN architecture, wherein cell configuration is controlled by means of one or more cell control information elements, IEs, facilitating control on a cell and/or slice level, wherein said control is effected via an E2 interface or an F1 interface.

In an embodiment, there is further provided a step of configuring a list of radio access network (RAN), parameters that are specific on the level of each public land mobile network (PLMN) cell or slice, and providing the same to an E2 node via the E2 interface to enable cell configuration in O-RAN, or to a cell on a distributed unit (DU) and/or central unit (CU) level, via the F1 interfaces.

In an embodiment, there is further provided a step of: determining IEs that needs to be controlled on a cell level for UE handover: and configuring one or more E2 nodes on a cell level via a service model and the IEs.

In an embodiment, there is further provided a step of: determining parameters that need to be controlled on a cell level for idle mode cell reselection; and configuring E2 nodes on a cell level through a corresponding service model and the IEs.

In an embodiment, there is further provided a step of: determining a parameter that needs to be controlled on a cell level and a slice level SLA assurance; and configuring E2 nodes on a cell level through a corresponding service model and the IEs.

In an embodiment, there is further provided a step of: determining a parameter that needs to be controlled on a cell level for cell barring; and configuring E2 nodes on a cell level through a corresponding service model and the IEs.

In an embodiment, there is further provided a step of: deciding to handover a user equipment (UE) to one or more E2 nodes from one or more E2 nodes, according to one or more of a load experienced by the E2 nodes, dynamic traffic and predicted service level agreement (SLA).

In an embodiment, there is further provided a step of: deciding to reselect a cell for idle UEs, for one or more E2 nodes, according to one or more of a load of the nodes, dynamic traffic and predicted SLA.

In an embodiment, there is further provided a step of the at least one intelligent system providing the E2 nodes with a list of cell IDs to initiate handover requests.

In an embodiment, there is further provided a step of the at least one intelligent system providing the E2 nodes with a list of cell IDs to receive handover requests.

In an embodiment, in the event that cell level or slice level configuration is needed, use cases including slice SLA assurance, mobility management and cell barring are used.

In an embodiment, the network comprises one or more xApps in a near-RT RIC; and/or one or more rAPPs in non-RT RIC.

In an embodiment, deciding to reselect a cell includes prediction of SLA for one or multiple slices or where prediction includes a prediction of network or computational resources in a slice.

According to a second aspect of the present invention, there is provided a network operable to perform the method of the first aspect.

The current invention will be based on, and provide extension to, E2SM-RC Control Header Format 2, to facilitate cell configuration in O-RAN. The invention also describes apparatus, methods, functions and interfaces based on an O-RAN architecture, to facilitate cell configuration in O-RAN.

In the following the terms E2 nodes, base station, and node are used interchangeably.

Embodiments of the present invention provide an apparatus and method for facilitating cell related resource control of an O-RAN architecture. Embodiments relate, in particular, to an apparatus and method for configuring cell related resource of the E2 nodes, through an E2 message and F1 messages, in accordance with an open radio access network (O-RAN) standard of a wireless communication system.

Although a few preferred embodiments of the present invention have been shown and described, it will be appreciated by those skilled in the art that various changes and modifications might be made without departing from the scope of the invention, as defined in the appended claims.

For a better understanding of the invention, and to show how embodiments of the same may be carried into effect, reference will now be made, by way of example only, to the accompanying diagrammatic drawings in which:

### BRIEF DESCRIPTION OF THE DRAWINGS

FIG. 1 shows a high level architecture of an open radio access network (ORAN).

FIG. 2 shows a radio access network (RAN) intelligent control (RIC) control header format.

FIG. 3A shows an E2 service model (E2SM) service model.

FIG. 3B shows a cell/slice service model according to an embodiment of the present disclosure.

FIG. 4A shows an illustration of handover decision making.

FIG. 4B shows an illustration of a machine leaning (ML)-based handover decision making.

FIG. 5A shows another illustration of handover decision making.

FIG. 5B shows a handover procedure initiated by xApps hosted a near-real time (RT) RIC, or rApps hosted by a non-RT RIC, according to an embodiment of the present disclosure.

FIG. 6 illustrates slice control according to an embodiment of the present disclosure.

FIG. 7 shows a message flow according to an embodiment of the present disclosure.

FIG. 8 shows adaptation of the physical resource block (PRB) portion by E2 Control message for slice service level agreement (SLA) assurance, according to an embodiment of the present disclosure.

FIG. 9 shows an illustration of cell-barring according to an embodiment of the present disclosure.

FIG. 10 shows an illustration of slice SLA assurance according to an embodiment of the present disclosure.

FIG. 11 shows a high level architecture for a mobility management O-RAN xApp according to an embodiment of the present disclosure.

FIG. 12 shows an illustration of an E2 service model on a cell level, according to an embodiment of the present disclosure.

FIG. 13 shows an illustration of a cell control CONTROL service style according to an embodiment of the present disclosure.

FIG. 14 shows how a mobility management decision is made/triggered according to the SLA prediction of slices according to an embodiment of the present disclosure.

### DETAILED DESCRIPTION

Terms used in the present disclosure are used only to describe specific embodiments, and may not be intended to limit the scope of other embodiments. The singular expression may include the plural expression unless the context clearly dictates otherwise. Terms used herein, including technical or scientific terms, may have the same meanings as commonly understood by one of ordinary skill in the art described in the present disclosure. Among the terms used in the present disclosure, terms defined in general dictionary may be interpreted with the same or similar meaning as the meaning in the context of the related art. Unless explicitly defined in the disclosure, it is not to be construed in an ideal or excessively formal meanings. In some cases, even terms defined in the present disclosure cannot be interpreted as exclude embodiments of the present disclosure.

In various embodiments of the present disclosure described below, a hardware approach is described as an example. However, since various embodiments of the present disclosure include a technology using both hardware and software, the various embodiments of the present disclosure do not exclude a software-based approach.

Terms that refer to signals (e.g., packets, messages, signals, information, signaling) used in the description below, terms that refer to resources (e.g., sections, symbols, slots, subframe, radio frame, subcarrier, resource element (RE), resource block (RB), bandwidth part (BWP), occasion), terms for the operation state (e.g., step, operation, procedure), terms referring to data (e.g., packet, message, user stream, information, bit, symbol, codeword), terms referring to channels, terms referring to network entities (distributed unit), radio unit (RU), central unit (CU), CU-control plane (CU-CP), CU-user plane (CU-UP), open radio access network (O-RAN) (O-DU), O-RAN RU (O-RU), O-RAN CU (O-CU), O-RAN CU-CP (O-CU-UP), O-RAN CU-CP (O-CU-CP), terms referring to components of the device, and the like are exemplified for convenience of description. Accordingly, the present disclosure is not limited to the terms described below, and other terms having equivalent technical meanings may be used. In addition, terms such as ‘ . . . part’, ‘ . . . group’, ‘ . . . water’, and ‘ . . . body’ used hereinafter refer to at least one shape structure or a unit for processing a function. can mean.

In addition, in the present disclosure, in order to determine whether a specific condition is satisfied or satisfied, an expression of greater than or less than may be used, but this is only a description for expressing an example. It's not about exclusion. Conditions described as ‘equal to or more than’ may be replaced with conditions described as ‘more than’. Conditions described as ‘equal to or less than’ may be replaced with conditions described as ‘less than’. Conditions described as ‘equal to or more than’ with ‘less than’ may be replaced with conditions described as ‘more than’ with ‘equal to or less than’. In addition, hereinafter, ‘A’ to ‘B’ means at least one of the elements from A to (including A) and from B (including B). The present disclosure describes various embodiments using terms used in some communication standards (e.g., 3rd Generation Partnership Project (3GPP), extensible radio access network (xRAN), and open-radio access network (O-RAN)). This is merely an example for description, and various embodiments of the present disclosure may be easily modified and applied in other communication systems.

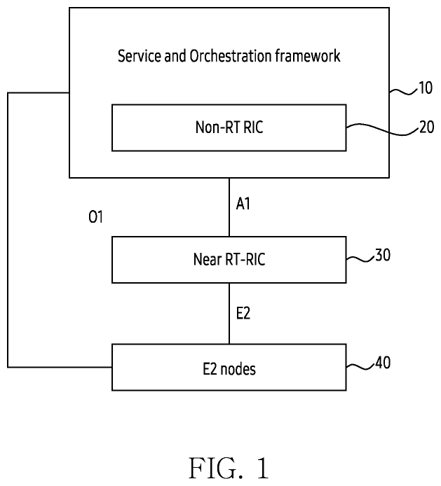

FIG. 1 shows a high level architecture of an open radio access network (ORAN).

FIG. 1 shows a schematic showing a general ORAN structure, including Service and Orchestration Framework 10, which includes a Non Real-Time (Non-RT) RAN Intelligent Controller (RIC) 20, which communicates with Near Real-Time (Near RT) RAN Intelligent Controller (Near-RT RIC) 30, which in turn communicates with the E2 nodes 40. The E2 nodes 40 have a direct communication path with the Service and Orchestration Framework 10.

In a nutshell, an open radio access network (O-RAN) defines radio units (RU), digital units (DU), control units (CU)-control plane (CP), and user planes (UP) as O-RAN RU (O-RU), O-DU, O-CU-CP, O-CU-UP.

A RAN intelligent controller (RIC) is a logical node that can collect information on cell sites transmitted and received by a user equipment (UE), O-eNB, O-DU, O-CU-CP, or O-CU-UP. The RIC can be implemented in the form of a server concentrated in one physical place or it can be implemented as a logical function within the base station (e.g., gNB). In the following, the nodes that are connected to RIC through the E2 interface, are referred to as E2 nodes. It is understood that concept presented herein are generally applied to E2 nodes, and it is an aim of embodiments of the invention is to present new parameters and procedures over the E2 interface, regardless of what the E2 nodes are. Here, E2 nodes may be understood as objects constituting a RAN that can operate according to the O-RAN standard, and may be referred to as an E2 node. An E2 node may also refer to an O-eNB.

Applications known as xApps can be developed in the Near-RT RIC and provide control to the RAN functions in the E2 nodes. Such examples can be found in the “O-RAN Architecture Description” v4.0. Applications known as rApps can developed in the Non-RT RIC as a platform application that provides an analytics-related function and RAN governing policy function.

The interface with the RANs that can operate according to the O-RAN standard between RIC and E2 nodes uses an application protocol (E2AP). As defined in O-RAN WG3, a given RAN Function offers a set of services to be exposed over the E2 using E2AP defined procedures. In one E2 Service Model (SM), E2SM Radio control, E2SM-RC, the E2 Node terminating the E2 Interface is assumed to host one or more instances of the RAN Function “RAN Control” which performs the following functionalities defined in O-RAN.WG3.E2SM-RC-v01.00.03:
E2 REPORT services used to expose RAN control and UE context related information
E2 INSERT services used to suspend RAN control related call processes
E2 CONTROL services used to resume or initiate RAN control related call processes, modify RAN configuration and/or E2 service related UE context information
E2 POLICY services used to modify the behaviour of RAN control related processes

It is noted, however, that the services that have been defined in the current E2SM-RC are at the UE level, and hence not suitable for cell-level or slice-level services. Embodiments of the invention aim to enable cell level resource configuration, to address a number of use cases such as RAN slicing Service Level Agreement (SLA) Assurance. It is noted here that RAN slicing SLA is considered as an example use case and a scenario related to it is considered, but it is understood that enabling the cell configuration can address a number of use cases in addition to slice SLA assurance, where cell level configuration is essential.

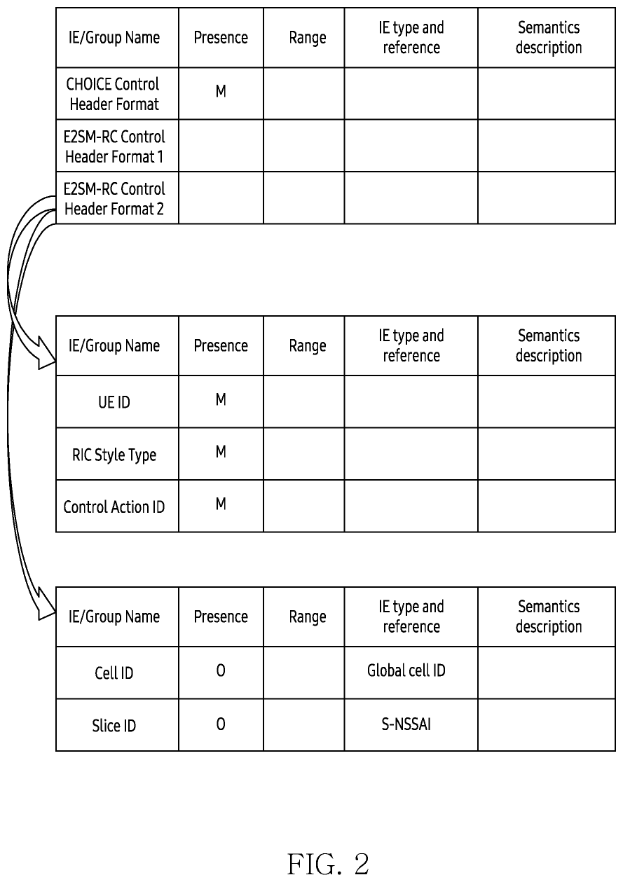

FIG. 2 shows a radio access network (RAN) intelligent control (RIC) control header format.

In a recent development towards cell and slice level services, it has been proposed that RIC control Header Format 2 should be adopted, as shown in FIG. 2.

In an example embodiment, the RIC control header format includes at least one of Cell ID and Slice ID. The RIC control header format includes Cell ID using a global cell ID. The RIC control header format includes Slice ID using single-network slice selection assistance information (S-NSSAI).

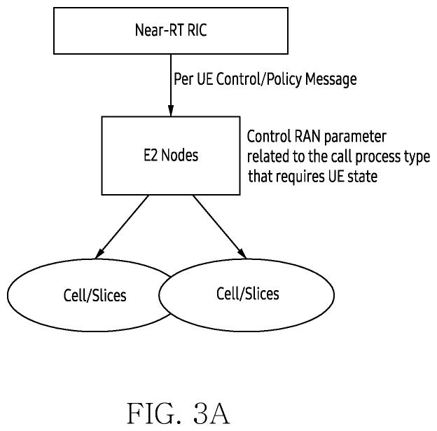

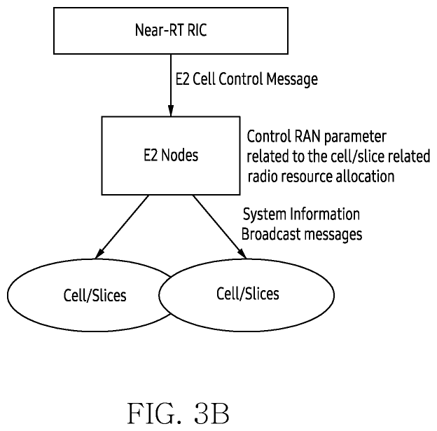

FIG. 3A shows an E2 service model (E2SM) service model.

FIG. 3B shows a cell/slice service model according to an embodiment of the present disclosure.

An illustration of the new service model, compared to available existing service model, is shown in FIGS. 3A and 3B, where FIG. 3A illustrates an existing E2SM service model and FIG. 3B illustrates a cell/slice level service model according to an embodiment of the invention.

Specifically, embodiments of the invention provide an apparatus and method for configuring a list of RAN parameters that are specific on the level of each Public Land Mobile Network (PLMN), Cell and/or Slice, to the E2 nodes, to enable cell configuration in O-RAN. The configuration can also be achieved by configuring the E2 nodes via E2 interfaces, or the cells on a DU/CU level, via the F1 interfaces.

Such a configuration is useful to address a number of use cases where cell level configuration is essential. An example of such a case is RAN slicing service level agreement (SLA). In this example, it is noted that there are a number of mechanisms to fulfil SLA in the radio access network. Embodiments of the current invention concern cell configuration in O-RAN, including new parameters (information elements, IEs) and procedures, to meet the requirements of SLA in a cell, slice and PLMN. Embodiments of the current invention, including the new service model ((E2SM-cell control (E2SM-CC)) and the methods of configuring RAN parameters at the cell level, slice level, and CU/DU level, are detailed in the following. It will be readily understood by those skilled in the art that the service model and method of configuring such parameters, are generally applicable to other use cases, whether different network configurations or other variations of the following. The term ‘E2SM-CC’ may be referred as the term E2SM-cell configuration control (E2SM-CCC).

In an embodiment of the invention, the proposed cell configuration is related to mobility control.

It is noted that, in the prior art, mobility control/management can be initiated by a UE or a network node (e.g., a base station), based on the measurements from the UEs such as Reference Signal Received Power (RSRP) Reference Signal Received Quality (RSRQ), to increase (or maximize) the Quality of Service (QOS), of the UE, without considering the constraints at the E2 nodes (e.g., network constraints as well as computational resources) and/or the slices (e.g., number of Physical Resource Blocks (PRBs) that the slice can accommodate).

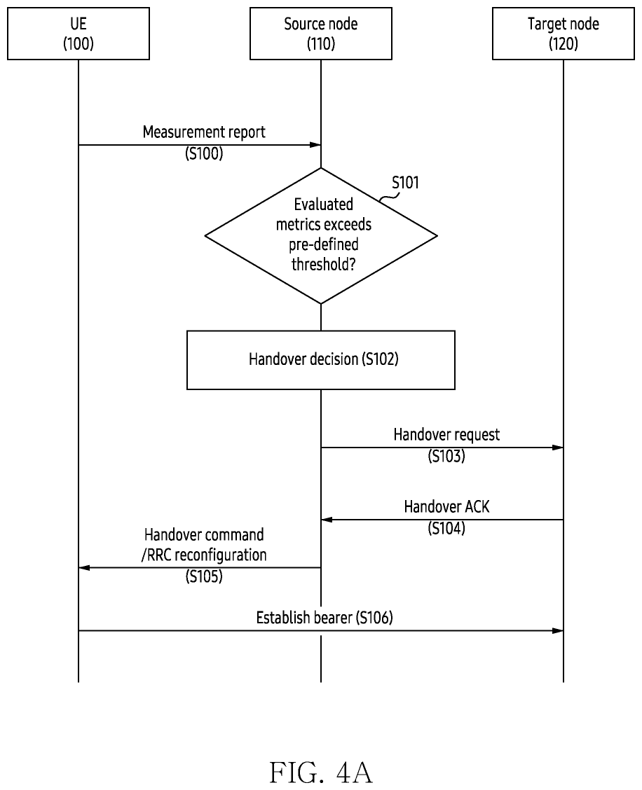

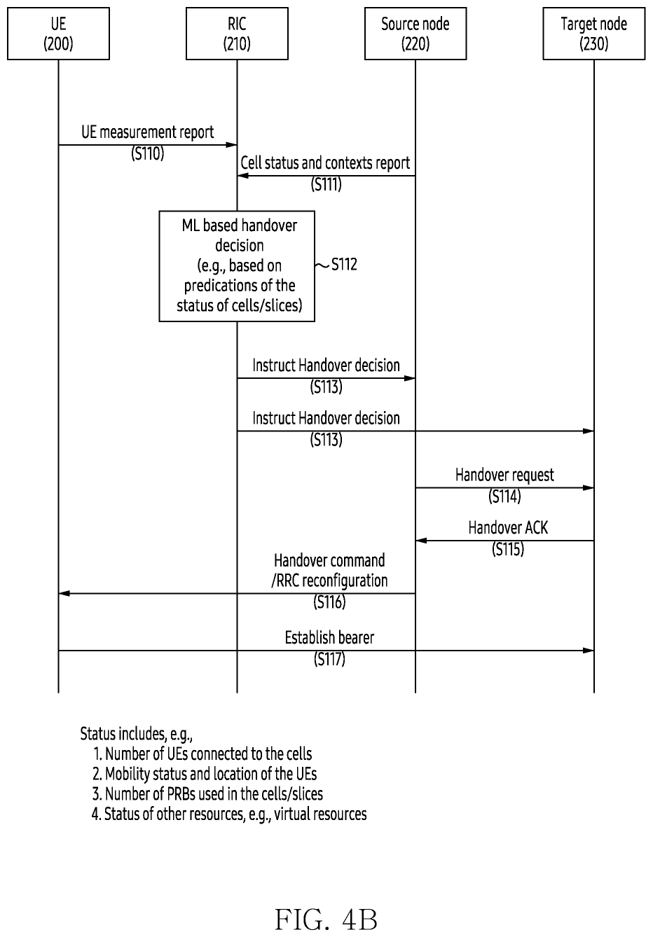

FIG. 4A shows an illustration of handover decision making.

FIG. 4B shows an illustration of a machine leaning (ML)-based handover decision making.

For example, in the prior art, handover decisions are made based on an evaluation of the handover metrics in a target cell and adjacent cells. The cells are selected based on the metrics and corresponding thresholds, for example. FIG. 4A illustrates such a prior art handover decision making process and FIG. 4B illustrates the concept of using Machine Learning/Artificial Intelligence (ML/AI), for handover decision making.

FIG. 4A shows message exchanges S100-S105 between entities UE 100, source node 110 and target node 120. Since this is well known prior art, full details are not provided here.

FIG. 4B shows message exchanges S110-S117 between entities UE 200, RIC 210, source node 220 and target node 230, when a handover optimisation xApp is applied to the O-RAN architecture. Since this is well known prior art, full details are not provided here.

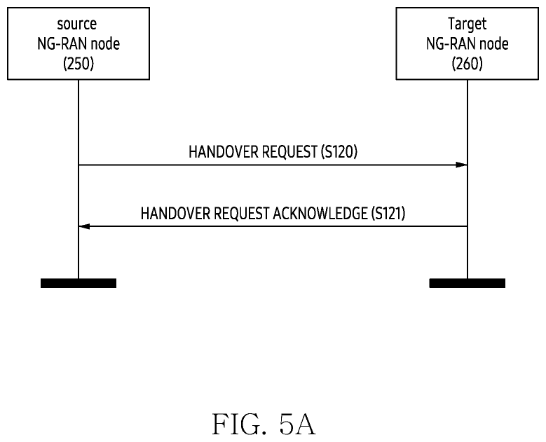

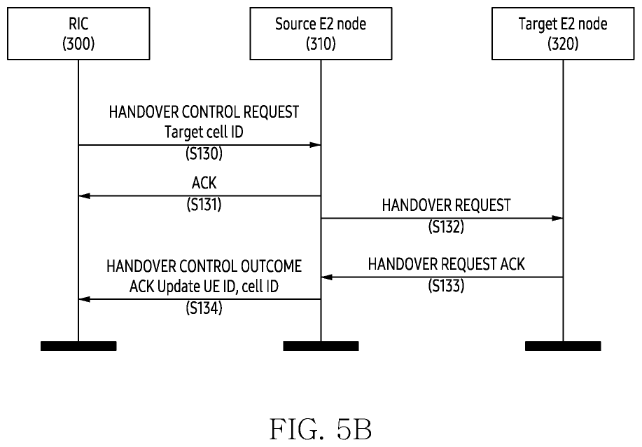

FIG. 5A shows another illustration of handover decision making.

FIG. 5B shows a handover procedure initiated by xApps hosted a near-real time (RT) RIC, or rApps hosted by a non-RT RIC, according to an embodiment of the present disclosure.

Work has been done to enhance handover by optimising the network parameters, e.g., optimising the pre-defined thresholds e.g., TimeToTrigger, Hysteresis, Cell individual offset, to enhance UE mobility. The approach taken in an embodiment of the current invention differs, in the sense that:
1) RIC gives instructions (or intention of handovers) to source/destination E2 nodes rather than adjusting the offsets and network parameters;
2) as a result, the handover (or the intention of it) is initiated by a RIC (within which, there is a mobility management xApp or slice management xApp), while in a conventional handover, the handover process would be initiated by a UE, or a network node, e.g., the source node. FIG. 5A illustrates the prior art, whereas FIG. 5B illustrates an approach adopted by an embodiment of the invention.

In FIG. 5A, source node 250 makes a handover request S120 to target node 260. If successful, target node 260 replies to source node 250 with a handover request acknowledge message S121.

In FIG. 5B, RIC 300 sends message S130 which is a handover control request, including Target Cell ID to Source E2 node 310. Source node 310 acknowledges S131 and then sends a handover request S132 to the target node 320. Target node 320, acknowledges the request S133. Source node 310 then sends a Handover control outcome message to RIC 300, including Update UE ID and cell ID.

Embodiments of the present invention also provide an apparatus and method for configuring an E2 node by the RIC according to the aforementioned procedures, so that the E2 node, when belonging to the specific slice or the list of the cells in the handover instruction provided by RIC, performs UE handover accordingly. The apparatus and method also provide for configuring an E2 node by the Non-RT RIC through the O1 management interface, as well as by configuring the DU through the F1 interfaces.

The E2 Control message, related to handover, includes the following information in the Table 1.

TABLE 1
EventTriggerConfig

eventId

| | |
|---|---|
| eventAN | This structure is applicable for A1, A2, A3, A4, A5 and A6 |
| Threshold | RSRP, RSRQ or SINR threshold (only for A1, A2, A4, and |
| | A5) |
| Threshold2 | RSRP, RSRQ or SINR threshold (only for A5) |
| Offset | RSRP, RSRQ or SINR offset (only for A3 and A6) |
| reportOnLeave | BOOLEAN (only for A3, A4, A5, and A6) |
| hysteresis | INTEGER (0 . . . 30), hysteresis parameter [dB], ensures that |
| | Event A3 is not reported until the RSRP difference |
| | between the serving and the neighbour cell is equal to the |
| | hysteresis |
| timeToTrigger | 0, 40, 64, 80, . . . 5120 msec. The time [ms] during which |
| | specific criteria for the event needs to be met in order to |
| | trigger a measurement report from UE to the network (the |
| | parameter is set per measurement event defined for cells |
| | on a specific carrier frequency). |
| useWhiteCellList | BOOLEAN |
| Cell individual offset | offset parameter [dB], added to RSRP measurement of |
| | neighbour cell (optional) |

In another embodiment of the invention, the cell configuration is related to cell reselection when the UEs are in idle mode. Although the description above focuses on handover, it is understood that the same principle and corresponding parameters are also applied to cell reselection, when UEs are in the idle state.

The E2 Control message related to cell reselection includes the following information in Table 2.

TABLE 2

| Information elements | Description |
|---|---|
| absThreshSS- | This specifies minimum threshold of the beam which can be |
| BlocksConsolidation | used for selection of the highest ranked cell, if |
| | rangeToBestCell is configured. |
| cellReselectionPriority | This specifies the absolute priority for NR frequency or E- |
| | UTRAN frequency. |
| cellReselectionSubPriority | This indicates fractional value to be added to the value of |
| | cellReselectionPriority |
| Qoffsets,n | This specifies the offset between the two cells. |
| Qoffsetfrequency | Frequency specific offset for equal priority NR frequencies. |
| Qhyst | This specifies the hysteresis value for ranking criteria. |
| Qoffsettemp | This specifies the additional offset to be used for cell |
| | selection and re-selection. It is temporarily used in case the |
| | RRC Connection Establishment fails on the cell as specified |
| | in TS 38.331 [3]. |
| Qqualmin | This specifies the minimum required quality level in the cell |
| | in dB. |
| Qrxlevmin | This specifies the minimum required Rx level in the cell in |
| | dBm. |
| Qrxlevminoffsetcell | This specifies the cell specific Rx level offset in dB to |
| | Qrxlevmin. |
| Qqualminoffsetcell | This specifies the cell specific quality level offset in dB to |
| | Qqualmin. |
| rangeToBestCell | This specifies the R value range which the cells whose R |
| | value is within the range can be a candidate for the highest |
| | ranked cell. It is configured in SIB2 and used for intra- |
| | frequency and equal priority inter-frequency cell reselection |
| | and among the cells on the highest priority frequency(ies) for |
| | inter-frequency cell reselection within NR. |
| TreselectionRAT | This specifies the cell reselection timer value. For each target |
| | NR frequency and for each RAT other than NR, a specific |
| | value for the cell reselection timer is defined, which is |
| | applicable when evaluating reselection within NR or towards |
| | other RAT (i.e. TreselectionRAT for NR is TreselectionNR, |
| | for E-UTRAN TreselectionEUTRA). TreselectionRAT is |
| | not broadcast in system information but used in reselection |
| | rules by the UE for each RAT. |
| TreselectionNR | This specifies the cell reselection timer value |
| | TreselectionRAT for NR. The parameter can be set per NR |
| | frequency as specified in TS 38.331 [3]. |
| TreselectionEUTRA | This specifies the cell reselection timer value |
| | TreselectionRAT for E-UTRAN. |
| ThreshX, HighP | This specifies the Srxlev threshold (in dB) used by the UE |
| | when reselecting towards a higher priority RAT/ frequency |
| | than the current serving frequency. Each frequency of NR |
| | and E-UTRAN might have a specific threshold. |
| ThreshX, HighQ | This specifies the Squal threshold (in dB) used by the UE |
| | when reselecting towards a higher priority RAT/ frequency |
| | than the current serving frequency. Each frequency of NR |
| | and E-UTRAN might have a specific threshold. |
| ThreshX, LowP | This specifies the Srxlev threshold (in dB) used by the UE |
| | when reselecting towards a lower priority RAT/ frequency |
| | than the current serving frequency. Each frequency of NR |
| | and E-UTRAN might have a specific threshold. |
| ThreshX, LowQ | This specifies the Squal threshold (in dB) used by the UE |
| | when reselecting towards a lower priority RAT/ frequency |
| | than the current serving frequency. Each frequency of NR |
| | and E-UTRAN might have a specific threshold. |
| ThreshServing, LowP | This specifies the Srxlev threshold (in dB) used by the UE |
| | on the serving cell when reselecting towards a lower priority |
| | RAT/ frequency. |
| ThreshServing, LowQ | This specifies the Squal threshold (in dB) used by the UE on |
| | the serving cell when reselecting towards a lower priority |
| | RAT/ frequency. |
| SIntraSearchP | This specifies the Srxlev threshold (in dB) for intra- |
| | frequency measurements. |
| SIntraSearchQ | This specifies the Squal threshold (in dB) for intra-frequency |
| | measurements. |
| SnonIntraSearchP | This specifies the Srxlev threshold (in dB) for NR inter- |
| | frequency and inter-RAT measurements. |
| SnonIntraSearchQ | This specifies the Squal threshold (in dB) for NR inter- |
| | frequency and inter-RAT measurements. |

In another embodiment of the invention, the cell configuration is performed via the CONTROL of master information block (MIB) and/or system information block 1 (SIB1) messages. In this case, the UE monitors downlink-shared channel (DL-SCH) during idle mode to retrieve these SIBs for the preparation of cell reselection. Then the UE makes cell measurements based on the received parameters. The parameter for NR cell reselection broadcasted in SIB 2˜5 are as follows:
SIB2: Cell reselection parameters other than neighboring cell related
SIB3: neighboring cell related info only for Intra-freq cell reselection parameters
SIB4: neighboring cell related Inter-Freq cell reselection
SIB5: Inter-RAT cell reselection

In another embodiment of the invention, the cell configuration is performed via the CONTROL parameters, IEs, related to RAN slicing and SLA assurance.

In an O-RAN Network, slicing is one of the key features which provides end-to-end Slice connectivity that fill in the gap of 3GPP's Network Slicing. These requirements include AI/ML optimized, Access Network and Transport Network slice capabilities. One of the applications of Network Slice in O-RAN, is the SLA Assurance which enables the closed loop control mechanisms to ensure slice SLAs are met and prevent possible violations. O-RAN's open interfaces and AI/ML based architecture enable such challenging mechanisms to be implemented and help operators to realize the opportunities of network slicing in an efficient manner.

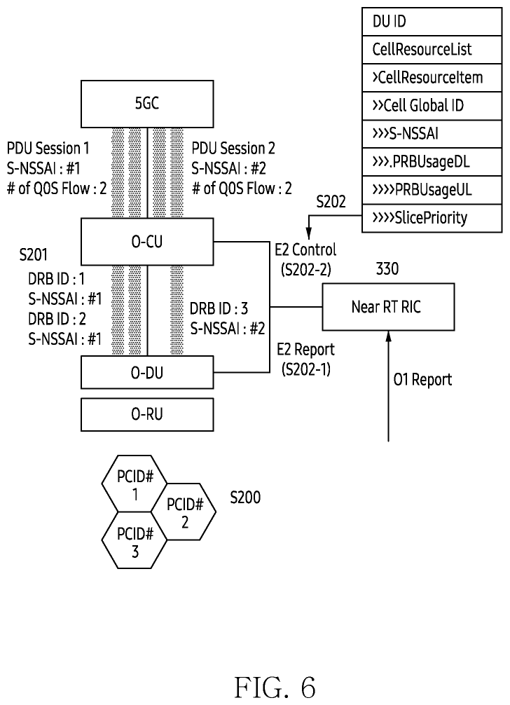

FIG. 6 illustrates slice control according to an embodiment of the present disclosure.

FIG. 6 illustrates the overall SLA assurance process over the Network slice. As per the 3GPP standard, 5GC has the network slice information per PDU session that is represented by Single-Network Slice Selection Assistance Information (S-NSSAI). S-NSSAI is made of Slice/Service Type (SST)(e.g., 8 bits) and Service Differentiator (SD)(e.g., 24 bits (Optional)). Each S-NSSAI can have special traffic characteristics, such as enhanced mobile mroadband (eMBB) or ultra-reliable low latency communications (URLLC).

In Step S200, the isolated slice capacities for each cell are setup during the initial cell configuration state when the RAN system is configured from EMS. In Step S201, once the Slice resources are reserved for each cell, the UE can be allocated to the desired slice. Since a PDU session can have multiple QoS flows and data radio bearers (DRBs), multiple DRBs and QoS flows can map to the single S-NSSAI. These mappings can be established during the UE's initial attach procedure. Lastly in Step S202, the Near-RT RIC 330 can perform closed-loop control on the Slice resource, based on the O1 and E2 key performance index (KPI) Report.

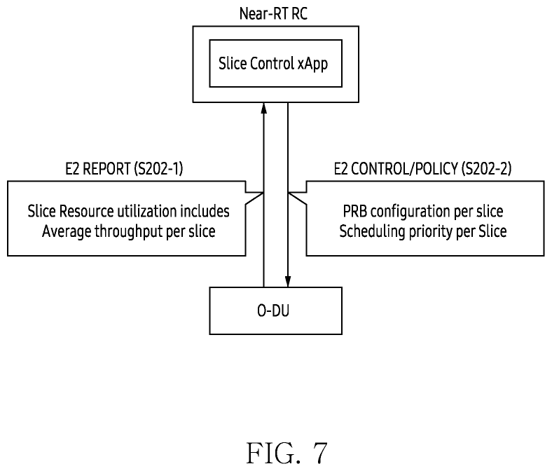

FIG. 7 shows a message flow according to an embodiment of the present disclosure.

FIG. 7 illustrates in more detail, certain flows of step S202 shown in FIG. 6. Step S202 is made of E2 REPORT service S202-1 and E2 CONTROL/POLICY service S202-2. During the E2 REPORT service procedure S202-1, the O-DU can report Slice Resource utilization that includes the DL/UL average throughput per slice, DL/UL Total PRB usage per slice. Based on the received E2 REPORT, the Slice Control xApp can determine the SLA violation for each cell and start the E2 CONTROL/POLICY procedure that will extend the capacities of the slice by either minimizing or maximizing the PRB portion of the slice, as well as the scheduling the priority of the slice.

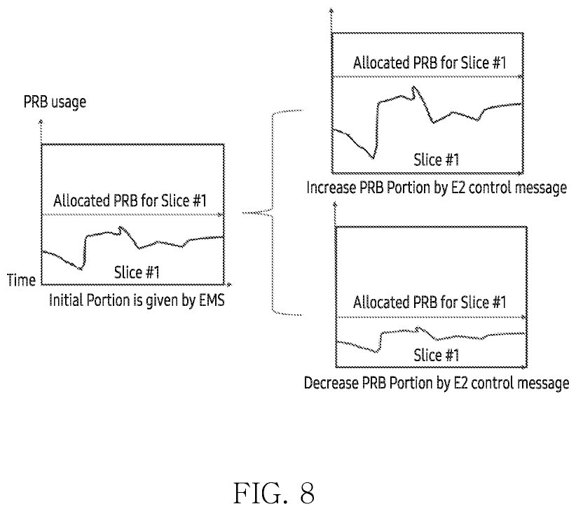

FIG. 8 shows adaptation of the physical resource block (PRB) portion by E2 Control message for slice service level agreement (SLA) assurance, according to an embodiment of the present disclosure.

FIG. 8 illustrates how the slice portion could be controlled by different approaches. The graph on the left shows an initial portion of PRB allocation, given by EMS. The upper and lower graphs on the right show, respectively, how the PRB portion allocation may be increased or decreased by means of an E2 control message. This is to ensure slice SLA assurance in particular cases.

The E2 Control message in this case includes the following information in Table 3. The listed information is the minimum set of the information, each information could be included into the E2SM-CC Control Header message and E2SM-CC Control message.

TABLE 3

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | | | YES | reject |
| DU ID | M | | DU ID to | YES | reject |
| | | | distinguish DU | | |
| CellResourceList | | 1 | | YES | reject |
| >CellResourceItem | | 1 . . . | | — | |
| | | <maxCellingNBDU(=512)> | | | |
| >>Cell Global ID | M | | NR CGI | YES | reject |
| | | | A cell that is | | |
| | | | serving the UE, | | |
| | | | either PCell or | | |
| | | | SCell | | |
| >>>S-NSSAI | O | | Slice ID | — | |
| >>>MaxSlicePrbPortion | O | | MaxPRB per slice | — | |
| | | | portion in | | |
| | | | Percentage | | |
| >>>MinSlicePrbPortion | O | | MinPRB per slice | — | |
| | | | portion in | | |
| | | | Percentage | | |
| >>>DLSliceScheduling Priority | O | | 5QI per slice | — | |
| >>>ULSliceScheduling Priority | O | | 5QI per slice | — | |

Table 4 below shows E2SM-CC Control header format. The format can be expandable if the new format needed.

TABLE 4

| | | | | |
|---|---|---|---|---|
| | | | IE type and | Semantics |
| IE/Group Name | Presence | Range | reference | description |

| | | |
|---|---|---|
| CHOICE Control Header Format | M | |
| >E2SM-CC Control Header Format 1 | | x.x.x.x |

Below, Table 5 shows detail of the E2SM-CC Control header format 1. The control header contains the key information for the cell control. The Global E2 Node ID indicates which E2 Node that Near-RT RIC controls, Cell global ID and PLMN ID indicate the target NR CGI for the slice control while Slice ID is S-NSSAI for the resource control. Control Action ID uniquely identifies an action of a given Cell Control action.

TABLE 5

| | | | | |
|---|---|---|---|---|
| IE/Group Name | Presence | Range | IE type and reference | Semantics description |

Global E2 Node ID
Cell Global ID
PLMN ID
Slice ID
Control Action ID

With the given key information in the E2SM-CC Control header format 1, the slice resource for the SLA assurance can be controlled as shown in Table 6 below, which shows Slice resource information in the E2SM-CC Control message format 1.

TABLE 6

| | | | | |
|---|---|---|---|---|
| | | | IE type and | Semantics |
| IE/Group Name | Presence | Range | reference | description |

| | | |
|---|---|---|
| CHOICE Control Message Format | M | |
| >E2SM-CC Control Message Format 1 | | x.x.x.x |

E2SM-CC Control Message Format 1 contains the information shown below in Table 7, which can control maximum PRB portion of the slice, minimum PRB portion of the slice. DL/UL slice scheduling priority by 5QI information can optimize the latency of the cell.

TABLE 7

| | | |
|---|---|---|
| >>>MaxSlicePrbPortion | O | MaxPRB per slice |
| | | portion in |
| | | Percentage |
| >>>MinSlicePrbPortion | O | MinPRB per slice |
| | | portion in |
| | | Percentage |
| >>>DLSliceScheduling Priority | O | 5QI per slice |
| >>>ULSliceScheduling Priority | O | 5QI per slice |

In another embodiment of the invention, the cell configuration is performed via the CONTROL parameters, IEs, related to cell barring.

The Cell barring feature in a cellular network controls the UE access to the RAN and the core network. By barring the selected cells, the UEs camping on these cells are required to reselect another cell in the network. In 5G NR, there are two mechanisms which allow an operator to impose cell reservations or access restrictions in NR. The first mechanism uses an indication of cell status and special reservations for control of cell selection and reselection procedures. The second mechanism, referred to as Unified Access Control, UAC, allows preventing selected access categories or access identities from sending initial access messages for load control reasons.

To indicate the Cell barring status of a particular cell, the gNB broadcasts the Cell Barring related information over the MIB and SIB1 Broadcast messages.

Cell status and cell reservations are indicated in the MIB or SIB1 message as specified in TS 38.331 by means of three fields:
1) cellBarred (IE type: “barred” or “not barred”)
   Indicated in MIB message. In case of multiple PLMNs indicated in SIB1, this field is common for all PLMNs
2) cellReservedForOperatorUse (IE type: “reserved” or “not reserved”)
   Indicated in SIB1 message. In case of multiple PLMNs indicated in SIB1, this field is specified per PLMN.
3) cellReservedForOtherUse (IE type: “true”)
   Indicated in SIB1 message. In case of multiple PLMNs indicated in SIB1, this field is common for all PLMNs.
   When cell status is indicated as “true” for other use, the UE shall treat this cell as if cell status is “barred”.

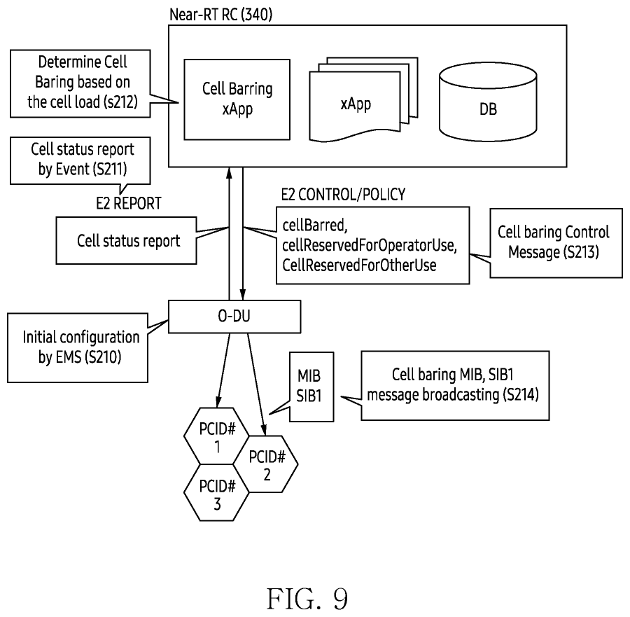

FIG. 9 shows an illustration of cell-barring according to an embodiment of the present disclosure.

The near-RT RIC 340 can directly control those parameters as illustrated in FIG. 9.

In Step S210 O-DU is configured by MIB and SIB1 information through EMS. During this operation, O-DU reports the cell status through E2 REPORT service message in Step S211. In Step S212, the Cell Barring xApp installed in the Near-RT RIC 340 continues monitoring the cell usage in the given PLMN. If cell overload is determined in Step S212, Cell Barring xApp will trigger E2 CONTROL/POLICY Service message, as step S213, that contains the following IEs; cellBarred, cellReservedForOtherUse, cellReservedForOperatorUse. Based on the Action information in the E2SM-CC Control Header field, the O-DU shall start broadcasting, as step S214, MIB and SIB1 information with the updated information.

The E2SM-CC Control Header message format illustrated in Table 5 can be used for the Cell barring Control message while it will require the new E2SM-CC Control message Format 2 which is illustrated below in Table 8.

TABLE 8

| | | | | |
|---|---|---|---|---|
| | | | IE type and | Semantics |
| IE/Group Name | Presence | Range | reference | description |

| | | |
|---|---|---|
| CHOICE Control Message Format | M | |
| >E2SM-CC Control Message Format 1 | | x.x.x.x |
| >E2SM-CC Control Message Format 2 | | x.x.x.x |
| cellBarred | O | ENUMERATED {barred, |
| | | notBarred} |
| cellReservedForOtherUse | O | ENUMERATED {true} |
| cellReservedForOperatorUse | O | {reserved, notReserved} |

There follows an example scenario where an embodiment of the present invention can be applied. Here, the new service model, i.e., E2SM-CC, and the cell configuration can be used in practical scenarios.

An embodiment of the present invention relates to an apparatus and method for configuring cell related resource of the E2 nodes, through an E2 message and F1 messages, in accordance with an open radio access network (O-RAN) standard of a wireless communication system. An embodiment of the invention can be applied in an O-RAN architecture, to achieve SLA assurance, according to the contexts of the cells or the slices, e.g., number of UEs that are attached to the current cell/slice, their locations and speed, the number of PRBs that have been used. The decision can also be made based on a prediction from the RIC, in terms of the predicted resource usage, and number of UEs at the cell.

In another scenario, mobility management, according to one embodiment of the invention, is provided to guarantee the service level agreement (SLA) of a slice or multiple slices. In such a case, the mobility management is about to instruct the E2 nodes on handover (or the intention of handing over) the UEs to the E2 nodes that is associated with a slice for a particular same service, when there are multiple E2 nodes and slices available. Such a procedure is enabled according to the message format, cell and slice level configuration, and the new E2SM-CC service as set out herein.

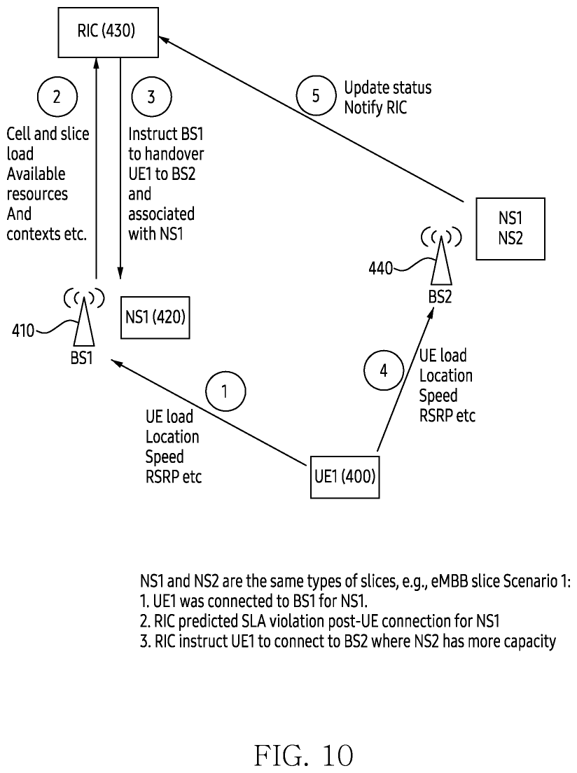

FIG. 10 shows an illustration of slice SLA assurance according to an embodiment of the present disclosure.

Such a scenario is illustrated in FIG. 10. As an example, UE1 400 is at the moment connected to base station 1 (BS1) 410 and associated with network slice 1 (NS1) 420. The procedure involved in the scenario is described as follows:
Step 1: UE 400 is being triggered or being configured to periodically report UE measurement report (e.g., its load, location, mobility status, service being consumed, RSRP etc.)
Step 2: Base station 1 (E2 node 1) 410 is being triggered or being configured to periodically report its measurement, including, for example, cell load, the PRBs that have been used, channel condition, beamforming, etc. All such information is provided to a RIC, for example, near-RT RIC 430.
Step 3: RIC 430 makes ML based handover decisions according to the predicted network contexts. The decision may be, for example, BS1 410 needs to handover UE1 400 to BS2 440 associated to NS1 420, following the procedure described previously.
Step 4: Handover is completed and UE 400 is now associated with BS2 440 and reports measurements to BS2 440.
Step 5: BS2 440 and associated NS update their contexts and notify RIC 430 about the outcome.

In an embodiment of the invention, the RIC maintains a database/repository of the available list of base stations and their contexts, to facilitate the RIC mobility management xApp/rApp to make the decision on handover accordingly.

In the following, various new parameters, interfaces, and procedures are described.

An embodiment of the invention provides:
1. A new enabler within near-RT RIC for RAN mobility management by dynamically making handover decisions according to the status/contexts of cells and slices. This includes a new xApp, namely the mobility management xApp, at the near-RT RIC. The new parameters that are passed from near-RT RIC to E2 nodes may include a list of cells that are available for UEs to handover to, and a list of cells that are available for the UEs to be handed-over from.
2. A new cell and slice control E2 service Model—namely the cell CONTROL service style between near-RT RIC and the cell control function at the E2 nodes, where the new control service allows the configuration of cell based mobility parameters, according to the actions from the xApp referred to in 1) above.
3. New E2 interfaces between near-RT RIC and the E2 nodes, where the interfaces are a list of parameters that are associated with each cell ID and/or with each slice ID (as in the table in FIGS. 1-1 RIC control Header format 2).
4. Reporting of the KPIs from E2 nodes to near-RT RIC (e.g., cell status, PRBs used, number of UEs, mobility etc.) through E2 interface.
5. A procedure related to enabling the mobility management xApp and its control of cell/slice specific parameters.

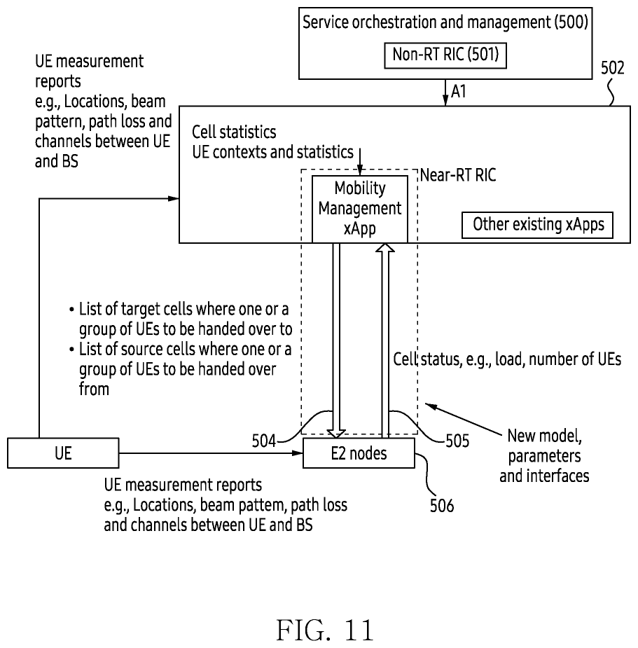

FIG. 11 shows a high level architecture for a mobility management O-RAN xApp according to an embodiment of the present disclosure.

FIG. 11 illustrates the high-level architecture of an embodiment of the present invention. As illustrated in FIG. 11, the non-RT RIC 501 within service orchestration and management framework 500 enables non-real-time control and optimization of RAN elements and resources and policy-based guidance to the applications/features in Near-RT RIC 502 through the A1 interface.

A new xApp, i.e., the mobility management xApp 503 is added in Near-RT RIC 502. The xApp 503 uses cell and UE statistics collected from non-RT RIC 501, such as load and UE mobility statistics. It then makes handover decisions according to, for example, predicted UE movement and the resulting SLA of the slice with which the E2 node is associated. Such a decision is made according to the real-time parameters obtained from the E2 interface, e.g., instantaneous cell load and KPIs of the E2 nodes. The output of the decision is a list of cells to be handed over to and from, i.e., a list of source E2 nodes and target E2 nodes. The source E2 nodes where the UEs will be handed over from, may include the list of E2 nodes whose resource is about to be used up and is predicted to overflow in the next time period. The target E2 nodes, where the UEs will be handed over to, may be determined by the fact that it is predicted that the resource of the target E2 nodes is (going to be) underutilized.

The decision made by xApp 503 may lead to an update of the list of the cells that are to be handed over from and to. These parameters 504 are passed from near-RT RIC 502 to the source and destination E2 nodes 506, and the E2 nodes 506 shall act accordingly, for example, following the procedures detailed in FIGS. 3B, 4B and 5B.

The E2 nodes 506 shall send their performance monitoring (e.g., throughput) to near-RT RIC 502 for 503 to update its decisions accordingly. The E2 nodes 506 shall also report status of handover that has happened to near-RT RIC 502, such that the reported information can be updated in the RIC data repository and used for other xApps, e.g., traffic steering. The parameters passed through the E2 interface, from E2 nodes 506 to near-RT RIC 502, are denoted as 505 in FIG. 11.

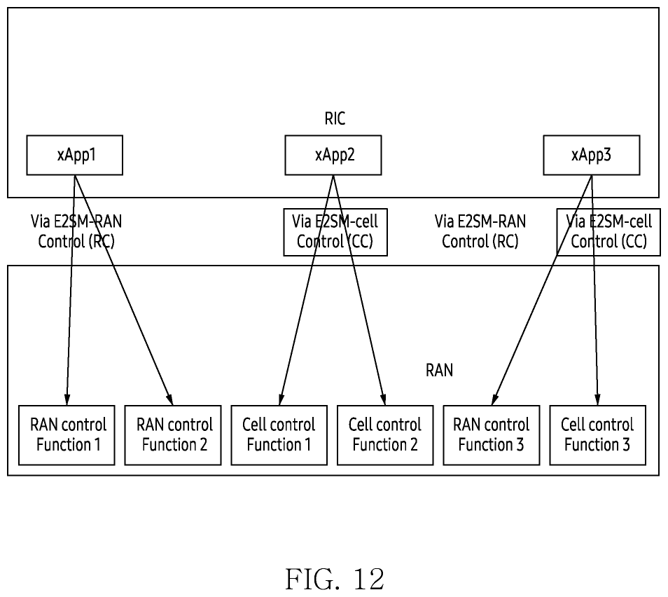

FIG. 12 shows an illustration of an E2 service model on a cell level, according to an embodiment of the present disclosure.

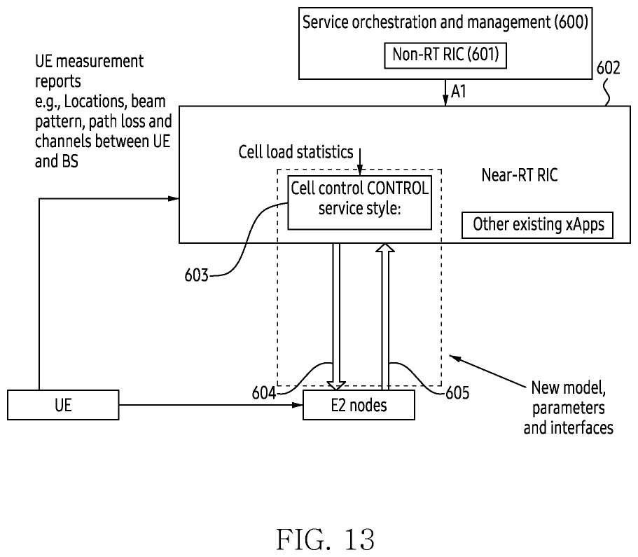

FIG. 13 shows an illustration of a cell control CONTROL service style according to an embodiment of the present disclosure.

In another embodiment of the invention, mobility management at the RAN is achieved by using a new E2 service model. In accordance with RIC control Header Format 2 or the E2SM-CC Control Header Format 1, this embodiment of the invention sets out a new E2 service model, referred to as E2SM-cell control (E2SM-CC) or E2SM-cell configuration control (E2SM-CCC), where the E2 service is at the cell and slice level, as opposed to the prior art E2SM-RC where the service is at the UE level. Correspondingly, there exist new RAN functions referred to as “Cell/Slice control” RAN functions. The relationship between the E2 service model and RAN functions are illustrated in FIG. 12 and FIG. 13, where it shows that a given xApp (or rApp in the case of non-RT RIC) can provide E2 services through E2SM-RC and E2SM-CC, namely two different service models that are been defined in O-RAN. In the case it is E2SM-RC, the RIC control Header Format 1 as shown in FIG. 2 should be used. In the case that it is E2SM-CC, the RIC control Header Format 2 or the E2SM-CC Control Header Format 1, as given in FIG. 1 and Table 6, respectively, should be used. It is shown in FIG. 12 that different xApps may use a different service model, according to the level of control and configuration needed. For example, one xApp may configure the E2 nodes at UE level, hence using E2SM-RC service model and corresponding IEs, whereas another xApp may configure the E2 nodes at the cell or slice level, hence using E2SM-CC service model and the corresponding IEs, whereas another xApp may configure the E2 nodes using both E2SM-CC and E2SM-RC. FIG. 13 gives an example of an interaction between an xApp and the E2 nodes via E2SM-CC, where 602 is near-RT RIC in O-RAN, within which an xApp controls and configures one or multiple E2 nodes. When such control is at the cell level and/or slice level, new IEs, containing new parameters (604 and 605) and control styles (603) are applied.

The table in FIG. 2 shows RIC Control Request Message format. The message format is made of message type, RIC Request ID, RIC Call Process ID, and RIC Control Header. The RIC Control header IE indicate the choices of E2SM-CC Control Message Header Format 1.

Specifically, the new style, namely ‘mobility management’, is added as a new RIC style to be added to the new E2SM-CC as in the table of FIG. 2. It indicates that, based on the O-RAN standard, the “RAN Control” RAN Function provides support of the CONTROL services on mobility Control, which is used for modification of the configuration and to control mobility configurations of one or multiple cells.

The CONTROL service style therefore further contains CONTROL Service RIC Control Message IE, where the contents of the RIC Control Message is the list of source and target cells/E2 nodes.

TABLE 9

| RAN | | RAN | |
|---|---|---|---|
| Parameter | RAN Parameter | Parameter | |
| ID | Name | Type | Parameter description |
| 1 | Source E2 | cell/E2 nodes | One or multiple cell/E2 nodes ID |
| | nodes | ID | where the UEs need to be handed |
| | | | over from |
| 2 | Target E2 | cell/E2 nodes | One or multiple cell/E2 nodes ID |
| | nodes | ID | where the UEs need to be handed |
| | | | over to |

The new CONTROL service style further contains information element (IEs) between Near-RT RIC and E2 nodes. Table 10, below, describes the message of the new E2SM-CC CONTROL service Style and the related IEs. These IEs, to be specified, perhaps in a new standard specification, in O-RAN E2SM-CC are detailed as follows.

Direction: Near-RT RIC to E2 node

TABLE 10

| | | | |
|---|---|---|---|
| Source | M | Global NG- | NG-RAN CGI of source cell for handover |
| cell | | RAN Cell | procedure (in NG-RAN node₂) |
| CGI | | Identity | |
| | | 9.2.2.27 | |
| Target | M | Global NG- | NG-RAN CGI of target cell for handover |
| cell | | RAN Cell | procedure (in NG-RAN node₁). |
| CGI | | Identity | If the Handover Report Type is set to “Inter- |
| | | 9.2.2.27 | system ping-pong”, it contains the target cell |
| | | | of the inter system handover from the other |
| | | | system to NG-RAN node 1 cell |

In another IE, a message is sent by the near-RT RIC to E2 nodes to request handover for one or multiple cells, as shown below in Table 11.

TABLE 11

| | | | | |
|---|---|---|---|---|
| | | | IE type | |
| IE/Group | | | and | |
| Name | Presence | Range | reference | Semantics description |

| | | | |
|---|---|---|---|
| Message Type | M | 9.2.3.1 | |
| Source NG- | M | NG-RAN | Allocated at the source NG-RAN |
| RAN node UE | | node UE | node |
| XnAP ID | | XnAP ID | |
| reference | | 9.2.3.16 | |
| Cause | M | 9.2.3.2 | |
| Target Cell | M | 9.2.3.25 | Includes either an E-UTRA CGI |
| Global ID | | | or an NR CGI |
| GUAMI | M | 9.2.3.24 | |

According to an embodiment of the present invention, a method performed by a radio access network (RAN) controlled controller (RIC) comprises the steps of: transmitting a RIC control request message to an E2 node; and receiving a RIC control confirmation message on the cell or slice level from the E2 node, wherein the RIC control request message includes information on a specific to RAN function specific to a service model, and the RIC control confirmation message for the function. The RIC control result information includes control result information, and the RIC control result information may include an event occurrence reason for the RAN function specific to the service model in a specific protocol.

According to an embodiment of the present invention, a method performed by an E2 node comprises the steps of: receiving a RIC control request message from a radio access network (RAN) control controller (RIC); and transmitting a RIC control confirmation message to the RIC. The RIC control request message includes information on a specific to RAN function specific to a service model, and the RIC control confirmation message includes information on the RIC control function. The RIC control result information includes control result information, and the RIC control result information may include an event occurrence reason for the RAN function specific to the service model in a specific protocol.

In example embodiments, a method performed by a near real time (near-RT)-radio access network (RAN) intelligence controller (RIC), the method comprises generating a control message for E2 service model (SM) providing one or more RAN functions associated with cell configuration and control. The method comprises transmitting, to a E2 node through E2 interface, the control message. The control message is used to configure at least one of cell level parameters or slice level parameters.

In an example embodiment, the control message is used for a slice resource allocation control. The control message includes single-network slice selection assistance information (S-NSSAI) indicating a network slice and physical resource block (PRB) allocation information associated with the network slice.

In an example embodiment, the control message includes information on a global cell identity (ID) and related parameters associated with the global cell ID.

In an example embodiment, the control message includes information on a public land mobile network (PLMN) and related parameters associated with the PLMN.

In an example embodiment, the one or more RAN functions provides a support of control services including at least one of a mobility management, service level agreement (SLA) assurance, or cell barring.

In example embodiments, a method performed by an E2 node, the method comprises receiving, from a near real time (near-RT)-radio access network (RAN) intelligence controller (RIC) through E2 interface, a control message for E2 service model (SM) providing one or more RAN functions associated with cell configuration and control. The control message is used to configure at least one of cell level parameters or slice level parameters.

In an example embodiment, the control message is used for a slice resource allocation control. The control message includes single-network slice selection assistance information (S-NSSAI) indicating a network slice and physical resource block (PRB) allocation information associated with the network slice.

In an example embodiment, the control message includes information on a global cell identity (ID) and related parameters associated with the global cell ID.

In an example embodiment, the control message includes information on a public land mobile network (PLMN) and related parameters associated with the PLMN.

In an example embodiment, the one or more RAN functions provides a support of control services including at least one of a mobility management, service level agreement (SLA) assurance, or cell barring.

In example embodiments, an apparatus of a near real time (near-RT)-radio access network (RAN) intelligence controller (RIC), comprises one or more transceivers. and one or more processors coupled to the one or more transceivers. The one or more processors are configured to generate a control message for E2 service model (SM) providing one or more RAN functions associated with cell configuration and control. The one or more processors are configured to transmit, to a E2 node through E2 interface, the control message. The control message is used to configure at least one of cell level parameters or slice level parameters.

In example embodiments, an apparatus of an E2 node, the apparatus comprises one or more transceivers and one or more processors coupled to the one or more transceivers. The one or more processors are configured to receive, from a near real time (near-RT)-radio access network (RAN) intelligence controller (RIC) through E2 interface, a control message for E2 service model (SM) providing one or more RAN functions associated with cell configuration and control. The control message is used to configure at least one of cell level parameters or slice level parameters.

In an embodiment of the invention, the mobility management xApp/procedure can run continuously, or be triggered by the operator or non-RT RIC (e.g., when KPI is not met by performance monitoring procedure).

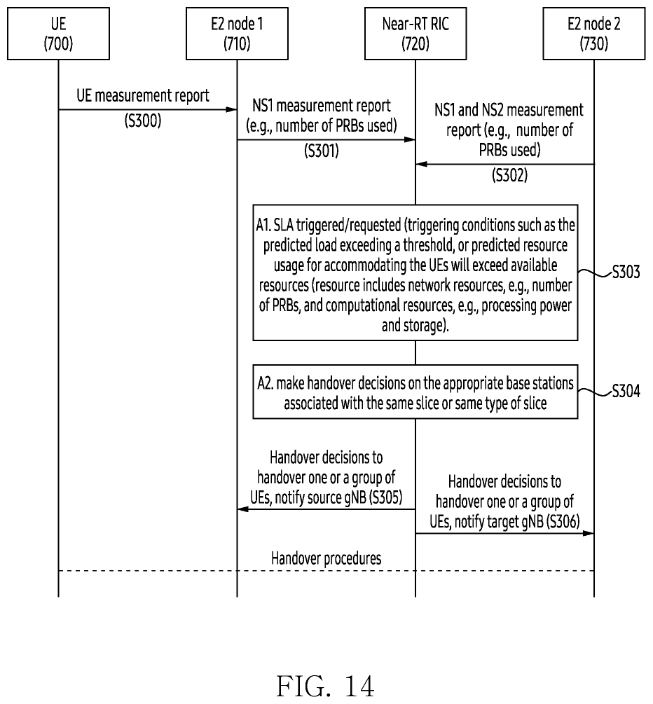

FIG. 14 shows how a mobility management decision is made/triggered according to the SLA prediction of slices according to an embodiment of the present disclosure.

In another embodiment of the invention, according to a scenario as illustrated in FIG. 14, a mobility management decision is made/triggered according to the SLA prediction of slices. This shows a mobility triggering condition on SLA assurance, based on predicted load exceeding a threshold, or predicted resource usage for accommodating the UEs will exceed available resources (resource includes network resources, e.g., number of PRBs, and computational resources, e.g., processing and storage).

In FIG. 14, there is shown a UE 700, an E2 Node 1 710, a Near-RT RIC 720 and an E2 Node 2 730. At step S300, UE 700 sends a measurement report to E2 Node 1 710. Then, each E2 Node sends NS1 or NS1/2 measurement report, respectively, to Near-RT RIC 720 at steps S301 and S302.

At step S303, SLA is triggered or requester. The triggering condition may be a predicted load exceeding a threshold or the predicted resource usage for accommodating the UEs will exceed available resources (e.g., number of PRBs or computation resources, such as processing power/storage).

At step S304, the Near RT RIC makes a handover decision on the appropriate base stations associated with the same slice or same type of slice.

At S305, the Near RT RIC 720 notifies the source gNB 710 of the decision to handover one or a group of UEs. At step S306, the Near RT RIC 720 notifies the target gNB 730 of the handover decision.

In embodiments according to the present disclosure, a method operating in a network, the network comprising at least one intelligent system and the network being configured in an O-RAN architecture. Cell configuration is controlled by means of one or more cell control information elements (IEs) facilitating control on a cell and/or slice level. The control is effected via an E2 interface or an F1 interface.

In an example embodiment, the method comprises configuring a list of Radio Access Node, RAN, parameters that are specific on the level of each Public Land Mobile Network, PLMN, cell or Slice, and providing the same to an E2 node via the E2 interface to enable cell configuration in O-RAN, or to a cell on a DU/CU level, via the F1 interfaces.

In an example embodiment, the method comprises determining IEs that needs to be controlled on a cell level for UE handover. The method comprises configuring one or more E2 nodes on a cell level via a service model and the IEs.

In an example embodiment, the method comprises determining parameters that need to be controlled on a cell level for idle mode cell reselection. The method comprises configuring E2 nodes on a cell level through a corresponding service model and the IEs.

In an example embodiment, the method comprises determining a parameter that needs to be controlled on a cell level and a slice level SLA assurance. The method comprises configuring E2 nodes on a cell level through a corresponding service model and the IEs.

In an example embodiment, the method comprises determining at least one parameter that needs to be controlled on a cell level for cell barring. The method comprises configuring E2 nodes on a cell level through a corresponding service model and the IEs.

In an example embodiment, the method comprises deciding to handover a user equipment (UE) to one or more E2 nodes from one or more E2 nodes, according to one or more of a load experienced by the E2 nodes, dynamic traffic and predicted SLA.

In an example embodiment, the method comprises deciding to reselect a cell for idle UEs, for one or more E2 nodes, according to one or more of a load of the nodes, dynamic traffic and predicted SLA.

In an example embodiment, the method comprises further comprises the step of the at least one intelligent system providing the E2 nodes with a list of cell IDs to initiate handover requests.

In an example embodiment, the method comprises further the step of the at least one intelligent system providing the E2 nodes with a list of cell IDs to receive handover requests.

In an example embodiment, in the event that cell level or slice level configuration is needed, use cases including slice SLA assurance, mobility management and cell barring are used.

In an example embodiment, the network comprises one or more xApps in a near-RT RIC; and/or one or more rAPPs in non-RT RIC.

In an example embodiment, the deciding to reselect a cell comprises predicting SLA for one or multiple slices. The prediction includes a prediction of network or computational resources in a slice.

In an example embodiment, a network operates to perform the one of the methods.

In an example embodiment, a method operates in a telecommunication network, comprising one or more intelligent systems in the O-RAN architecture for cell resource configuration, comprising cell control information elements (IEs) on a cell and/or slice level, based on a new service model, E2SM-CC in O-RAN, via E2 interfaces.

In an example embodiment, a method operates in a telecommunication network, comprising one or more intelligent systems in the O-RAN architecture for cell resource configuration, comprising cell control information elements (IEs) on a cell and/or slice level, based on a new service model, E2SM-CC in O-RAN, via F1 interfaces.

In an example embodiment, the method comprises a method for configuring a list of RAN parameters that are specific on the level of each PLMN, Cell and/or Slice, to the E2 nodes, to enable cell resource configuration in O-RAN. The configuration can also be achieved by configuring the E2 nodes via E2 interfaces, or the cells on a DU/CU level, via the F1 interfaces.

In an example embodiment, The new E2SM-CC Control header format 1 (Table 7) according to the new service model E2SM-CC.

In an example embodiment, a method operates in a telecommunication network, comprising one or more intelligent systems in the O-RAN architecture, comprises determining the IEs that needs to be controlled on the cell level for UE handover, configuring the E2 nodes on the cell level through the corresponding service model and IEs, using the E2SM-CC Control Header Format 1.

In an example embodiment, a method of operating a telecommunication network, comprising one or more intelligent systems in the O-RAN architecture, comprises determining the parameters that needs to be controlled on the cell level for idle mode cell reselection. The method comprises configuring the E2 nodes on the cell level through the corresponding service model and IEs, and the E2SM-CC Control Header Format 1.

In an example embodiment, a method of operating a telecommunication network, comprising one or more intelligent systems in the O-RAN architecture, comprises determining the parameters that needs to be controlled on the cell level and slice level SLA assurance. The method comprises configuring the E2 nodes on the cell level through the corresponding service model and IEs defined in, and the E2SM-CC Control Header Format 1.

In an example embodiment, a method of operating a telecommunication network, comprising one or more intelligent systems in the O-RAN architecture, comprises determining the parameters that needs to be controlled on the cell level for cell barring. The method comprises configuring the E2 nodes on the cell level through the corresponding service model and IEs, and the E2SM-CC Control Header Format 1.

In an example embodiment, a method of operating a telecommunication network, comprising one or more intelligent systems in the O-RAN architecture, comprises making a decision on handover UEs to and from one or multiple E2 nodes, according to, for example but not limited to, the load of the nodes, dynamic traffic, predicted SLA etc. The method comprises configuring the E2 nodes through corresponding service model and IEs, and the E2SM-CC Control Header Format 1.

In an example embodiment, a method of operating a telecommunication network, comprising one or more intelligent systems in the O-RAN architecture, comprises making a decision on cell reselection for idle UEs for one or multiple E2 nodes, according to, for example but not limited to, the load of the nodes, dynamic traffic, predicted SLA etc. The method comprises configuring the E2 nodes through the corresponding service model and IEs.

In an example embodiment, the method further comprises the step of the one or more intelligent systems instructing the E2 nodes a list of cell IDs to initiate handover requests (source cell IDs).

In an example embodiment, the method further comprises the step of the one or more intelligent systems instructing the E2 nodes a list of cell IDs to receive handover requests (target cell IDs).

In an example embodiment, the method further comprises the procedures that enable O-RAN use cases such as slice SLA assurance, mobility management, cell barring, etc., where cell level and slice level configuration is needed.

In an example embodiment, the method further comprises the IEs reported to, and configured by, Near-RT RIC and non-RT RIC, according to the Tables and Figures given in the description.

In an example embodiment, the method further comprises one or multiple xApps in near-RT RIC; and/or one or multiple rAPP in non-RT RIC.

In an example embodiment, the decision making comprises prediction of the SLA for one or multiple slices. The prediction comprises the prediction of network (e.g., number of PRBs) and computational resources (e.g., processing power and storage) in the slices.

In an example embodiment, the “Cell Control” RAN Function to provide support of the CONTROL services on the cell and slice level.

Embodiments of the invention provide apparatus and methods in an O-RAN architecture in a wireless communication system to enable RAN a new service model (E2SM-CC), where RAN parameters that are specific to the level of each PLMN, Cell and/or Slice, are configured in the E2 nodes, to enable cell resource configuration in O-RAN.

The service model and method of configuring such parameters, according to an embodiment of the invention, are generally applicable to other use cases where cell level and slice level configuration is needed. Embodiments of the invention therefore relate to a wide range of potentially other use cases and related IEs and procedures.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A method performed by a near real time (near-RT)-radio access network (RAN) intelligence controller (RIC), the method comprising:
generating a control message for E2 service model (SM) providing one or more RAN functions associated with cell configuration and control; and
transmitting, to a E2 node through E2 interface, the control message,
wherein the control message is used to configure at least one of cell level parameters or slice level parameters.

2. The method of claim 1,
wherein the control message is used for a slice resource allocation control, and
wherein the control message includes single-network slice selection assistance information (S-NSSAI) indicating a network slice and physical resource block (PRB) allocation information associated with the network slice.

3. The method of claim 1, wherein the control message includes information on a global cell identity (ID) and related parameters associated with the global cell ID.

4. The method of claim 1, wherein the control message includes information on a public land mobile network (PLMN) and related parameters associated with the PLMN.

5. The method of claim 1, wherein the one or more RAN functions provides a support of control services including at least one of a mobility management, service level agreement (SLA) assurance, or cell barring.

6. A method performed by an E2 node, the method comprising:
receiving, from a near real time (near-RT)-radio access network (RAN) intelligence controller (RIC) through E2 interface, a control message for E2 service model (SM) providing one or more RAN functions associated with cell configuration and control,
wherein the control message is used to configure at least one of cell level parameters or slice level parameters.

7. The method of claim 6,
wherein the control message is used for a slice resource allocation control, and
wherein the control message includes single-network slice selection assistance information (S-NSSAI) indicating a network slice and physical resource block (PRB) allocation information associated with the network slice.

8. The method of claim 6, wherein the control message includes information on a global cell identity (ID) and related parameters associated with the global cell ID.

9. The method of claim 6, wherein the control message includes information on a public land mobile network (PLMN) and related parameters associated with the PLMN.

10. The method of claim 6, wherein the one or more RAN functions provides a support of control services including at least one of a mobility management, service level agreement (SLA) assurance, or cell barring.

11. An apparatus of a near real time (near-RT)-radio access network (RAN) intelligence controller (RIC), the apparatus comprising:
one or more transceivers; and
one or more processors coupled to the one or more transceivers, configured to:
generate a control message for E2 service model (SM) providing one or more RAN functions associated with cell configuration and control, and
transmit, to a E2 node through E2 interface, the control message,
wherein the control message is used to configure at least one of cell level parameters or slice level parameters.

12. The apparatus of claim 11,
wherein the control message is used for a slice resource allocation control, and
wherein the control message includes single-network slice selection assistance information (S-NSSAI) indicating a network slice and physical resource block (PRB) allocation information associated with the network slice.

13. The apparatus of claim 11, wherein the control message includes information on a global cell identity (ID) and related parameters associated with the global cell ID.

14. The apparatus of claim 11, wherein the control message includes information on a public land mobile network (PLMN) and related parameters associated with the PLMN.

15. The apparatus of claim 11, wherein the one or more RAN functions provides a support of control services including at least one of a mobility management, service level agreement (SLA) assurance, or cell barring.

16. An apparatus of an E2 node, the apparatus comprising:
one or more transceivers; and
one or more processors coupled to the one or more transceivers, configured to:
receive, from a near real time (near-RT)-radio access network (RAN) intelligence controller (RIC) through E2 interface, a control message for E2 service model (SM) providing one or more RAN functions associated with cell configuration and control,
wherein the control message is used to configure at least one of cell level parameters or slice level parameters.

17. The apparatus of claim 16,
wherein the control message is used for a slice resource allocation control, and
wherein the control message includes single-network slice selection assistance information (S-NSSAI) indicating a network slice and physical resource block (PRB) allocation information associated with the network slice.

18. The apparatus of claim 16, wherein the control message includes information on a global cell identity (ID) and related parameters associated with the global cell ID.

19. The apparatus of claim 16, wherein the control message includes information on a public land mobile network (PLMN) and related parameters associated with the PLMN.

20. The apparatus of claim 16, wherein the one or more RAN functions provides a support of control services including at least one of a mobility management, service level agreement (SLA) assurance, or cell barring.
